(19) United States
(12) Patent Application Publication
(10) Pub. No.: US 2010/0112314 A1
(43) Pub. Date: May 6, 2010

(54) Invisible Pigments and Ink

(75) Inventors: Yingqiu Jiang, Sunnyvale, CA (US); Aharon Hochbaum, Berkeley, CA (US)

Correspondence Address: Yingqiu Jiang, 1269 Poplar Ave, #203, Sunnyvale, CA, 94086, US

(73) Assignees: Yingqiu Jiang, Sunnyvale, CA (US); Aharon Hochbaum, Berkeley, CA (US)

(21) Appl. No.: 12/611,113

(22) Filed: Nov. 2, 2009

Related U.S. Application Data
(60) Provisional application No. 61/198,458, filed on Nov. 6, 2008.

(51) Int. Cl. B32B 3/00; C09D 11/00; B32B 5/16; C09D 17/00

(52) U.S. Cl. 428/199; 106/31.14; 428/323; 106/400; 252/299.7

(57) ABSTRACT

Methods of applying covert features using security inks comprise transparent chiral birefringent pigments or a mixture of transparent chiral birefringent pigments and reflective pigments are described. Hidden features appear to be bright and achromatic against dark background when overlaid with circular polarizer.

### CROSS REFERENCE TO RELATED APPLICATIONS

The present invention is related and claims priority to U.S. Provisional Patent Application, Ser. No. 61/198,458, entitled “Invisible Pigments and Ink” and filed on Nov. 6, 2008. The U.S. Provisional Patent Application is hereby incorporated by reference in its entireties.

### FIELD OF THE INVENTION

This invention relates to transparent pigments that are made of chiral birefringent liquid crystal polymers for covert security printing applications.

### BACKGROUND OF THE INVENTION

It is desirable to add security features to a variety of documents, articles, or product packages for authentication purposes. Holographic authentication features have been used for more than two decades and by now they are relatively easy to counterfeit. Recently optical variable pigments (OVP) were introduced to the market as a new technology for overt anti-counterfeiting applications. Among them, for example, ChromaFlair® (JDS Uniphase Flex Products Group in Santa Rosa, Calif.) and Helicone® (LCP Technology GmbH in Burghausen, Germany) are two products that are were adopted for optical security applications.

Both ChromaFlair® and Helicone® products are highly reflective in the visible spectrum and can be used for overt marking. They exhibit a unique color travel property that can be used in bank notes and other security printing, as well as for decorative applications. As the angle at which the surface is viewed is increasing, the perceived wavelength becomes shorter (“blue shift”). The Helicone® product, being a cholesteric liquid crystal polymer, has in addition a secondary security feature: it reflects and transmits opposite circular polarizations in a wavelength band corresponding to its reflective color.

UV fluorescence ink or patterned birefringent films are two examples of practical technologies that are used for covert markings. Patterned birefringent films are overlaid with a polarizer to reveal hidden images (e.g. U.S. Pat. No. 6,144,428). However, this approach requires patterning of features in an aligned polymerizable liquid crystal film and hence requires special and complex substrate coating, alignment and processing. A more recent technology invented by Karasev (U.S. Pat. No. 6,740,472) relates to the use of non-opaque latent image layer made in anisotropic polymer material which becomes visible when viewed with a polarizer. Both methods have the drawbacks of requiring complicated processes such as UV exposure through masks and/or special substrate treatment to create hidden images. Furthermore, these methods have a common drawback of material waste since only partial areas contain the hidden marks. It is very desirable to have the security medium in the form of pigments that can be simply printed by many of the existing printing technologies on a wide variety of substrates.

Non-chiral birefringent pigments technology recently disclosed by Hammond-Smith (U.S. Pat. No. 7,297,292) attempts to addresses the above problem. However, this technology is vulnerable to counterfeiting due to the availability of many other, functionally similar, birefringent pigments, such as mica or calcite pigments, or other pigments or flakes made by stretching synthetic polymer films.

Cholesteric liquid crystal materials (CLC) are an example of a chiral birefringent material that posses a periodic structure. When the period length (“pitch”) is in the 0.2-2 micrometers range, such materials posses a narrow polarized reflection band which is situated, depending on the pitch value, approximately within the 300-3000 nm wavelength range (UV-Visible-IR). Chiral birefringent materials and CLC in particular, are essentially transparent with the exception of the reflection band. In the 1980's, crosslinkable cholesteric liquid crystal materials were developed enabling the “locking-in” of their unique reflection properties. CLC polymers may be formed into pigments known also as “flakes” or “platelets”, for example, as disclosed in Faris U.S. Pat. Nos. 5,364,557, 5,599,412, and 6,338,807, which are incorporated by reference herein. Sicpa (LCP Technologies) launched the Helicone pigments, based on CLC pigments, for overt security printing applications.

Yet a covert security ink which can be detected using simple means, that is compatible with conventional printing processes, has low material waste, and is difficult to counterfeit is highly desirable.

### SUMMARY OF THE INVENTION

The above-discussed and other problems and deficiencies of the prior art are overcome or alleviated by the present invention.

As described herein, security pigment systems generally comprise composite of a reflective material and a security ink comprising transparent chiral birefringent material and a transparent carrier medium. In certain embodiments, the reflective material comprises a reflective base layer, upon which the security ink may be applied. In other embodiments, the reflective material comprises reflective pigments that are printed below the security ink or are mixed with the security ink. The security ink is invisible when viewed with naked eye and becomes visible as an achromatic bright mark on a dark background when viewed with a circular polarizer. Furthermore, the security ink possesses a selective wavelength reflection features and polarized reflection features that are detectable by detection devices.

The above-discussed and other features and advantages of the present invention will be appreciated and understood by those skilled in the art from the following detailed description and drawings.

### BRIEF DESCRIPTION OF THE DRAWINGS

FIGS. 1 and 2 show schematic sectional and top views, respectively, of a system according to an embodiment herein where transparent security inks are applied upon a reflective base layer. The mark is invisible (FIG. 2) to the naked eye;

FIGS. 3 and 4 show schematic sectional and top views, respectively, of a system according to the embodiment herein described with respect to FIGS. 1 and 2 where the transparent security mark becomes visible as a bright mark on a dark background when a circular polarizer is overlaid on the surface of an article having the herein security feature;

FIG. 5 shows a schematic sectional view of a system according to another embodiment herein wherein transparent security inks are mixed with reflective pigments and applied upon an arbitrary substrate. The article is viewable with or without the use of circular polarizer;

FIG. 6 shows a top view of another embodiment herein where an article is further encoded by application of transparent security inks that are mixed with reflective pigments upon certain parts of the article and reflective pigments only upon other parts of the article and viewed with naked eye.

FIGS. 7 and 8 show a schematic sectional and top views, respectively, of a system according to the embodiment of FIG. 6 herein where the parts encoded with a mixture of transparent security ink and reflective pigments become viewable and distinguishable from parts that contain only reflective pigments, when a circular polarizer is overlaid on the surface of an article having the herein security feature.

### DETAILED DESCRIPTION

Herein disclosed are security pigment systems generally a composite of a reflective material, and a security ink comprising transparent chiral birefringent material and a transparent isotropic carrier medium. In certain embodiments, the reflective material comprises a reflective base layer, upon which the security ink may be applied. In other embodiments, the reflective material comprises reflective pigments that are mixed with the security ink. The security ink is invisible when viewed with a naked eye. However, for authentication of the article upon which the composite of a reflective material and a security ink described herein is applied, an authenticator (e.g., including but not limited to a financial institution, consumer, retailer, or manufacturer) may view the article with a circular polarizer, whereafter the security ink is visible.

The security ink comprising transparent chiral birefringent material may be formed by breaking films of transparent chiral birefringent material into platelets, also referred to herein as flakes or pigments (generally having major surfaces corresponding to the faces of the films, and minor surfaces, or edges). For instance, cholesteric liquid crystal polymer films may be formed into small platelets, where each flake effectively retains the optical property of the film. The cholesteric helical axis is essentially perpendicular to the flakes major surfaces. In contrast to commercial CLC pigments products, which reflect part of the visible light wavelength in the 380-780 nm range, the chiral birefringent materials herein do not reflect light within the visible wavelengths.

In particular, in certain preferred embodiments herein, the pigments are platelets of CLC polymer film in which the reflection peaks are outside of the visible of spectra, e.g. in ultraviolet (UV) or infrared (IR) regions. The birefringence of these transparent CLC platelets in the visible spectrum is significant. For instance, the birefringence may be generally greater than about 0.01, preferably greater than about 0.1.

In one embodiment, the background or base layer is a highly reflective material that upon reflection inverts the circular sense of the incident circularly polarized light. For example, highly reflective material such as metallic or dielectric films may be employed. When such base material is overlaid with a circular polarizer it appears very dark. In certain preferred embodiments, the highly reflective material as a base layer comprises of aluminum.

To detect the security ink herein, a viewing polarizer is employed in the form of a circular polarizer. Either left-handed or right-handed circular polarizer can be used for detection. The circular polarizer circularly polarizes the incident light as well as enables analysis of the reflected light. The circular polarizer is overlaid upon the surface of the article containing the security ink.

In certain embodiments described herein, the security ink can also be mixed with reflective pigments formed from reflective materials in the visible spectrum such as metallic pigments, pearlescent pigments and/or optically variable pigments (OVP). In certain preferred embodiments, a highly reflective material used to form reflective pigments comprises metallic pigments. In this embodiment, the reflective pigments act as the reflective background for the security inks. The mixture may therefore be printed on any substrate, since the reflective pigments serve as reflectors for the security ink.

In further embodiments, the mixture of reflective pigments and security ink can be arranged in a manner whereby certain parts of the article contains only reflective pigments, and the other parts contain the mixture of the security ink and the reflective pigments. This arrangement allows the authenticator to encode covert features in different positions (as, for example, in FIG. 8) thus, further enhancing the anti-counterfeit aspects and making the encoding more difficult to forge.

In additional embodiments, the presence of a reflection band of the security ink in the UV or IR spectrum and/or the circular polarization nature of the reflection or transmission from this band can be used as a secondary detection feature. For instance, a spectrometer can be utilized to confirm the presence of a reflection band outside the visible wavelengths range. Alternatively, a detection system which admits a narrow wavelength range within the reflection band which is also equipped with a circular polarizer can verify the existence of the reflection band outside the visible range and that within this band the reflected light is predominantly circularly polarized. These secondary detection features provide means to distinguish CLC pigments from regular linear birefringent pigments thereby secure them from being counterfeited by the latter.

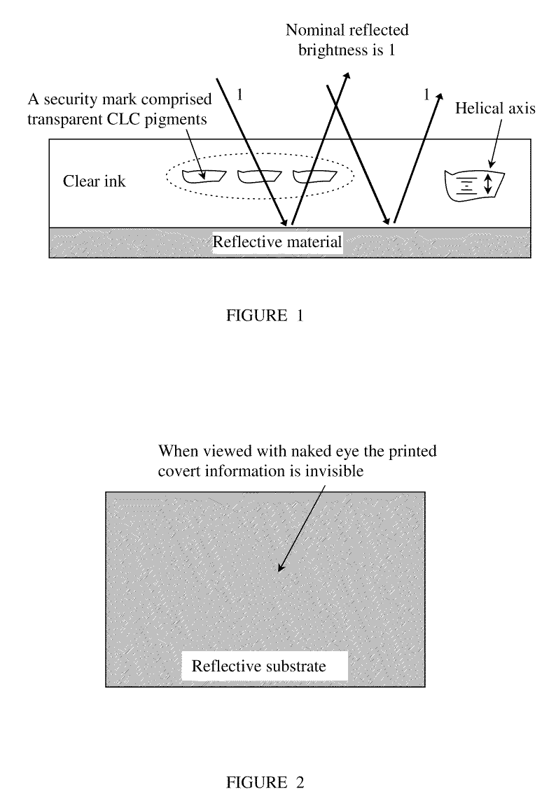

Referring now to FIGS. 1-4, schematics of an embodiment of the present invention are shown. As shown in FIGS. 1 and 2, security inks (e.g., transparent CLC pigments) appear invisible under normal illumination conditions and viewed with a naked eye. Reflected beam brightness is essentially the same (nominal brightness is “1”) whether the beam intersects the invisible pigments or not (see FIG. 1).

In one preferred embodiment as shown with respect to FIGS. 1-4, chiral birefringent pigments that are transparent to visible wavelengths, such as transparent CLC pigments, are mixed in a clear carrier, and are printed on a reflective surface. The printed surface is then over-coated with a clear ink. The indices of refraction of the transparent chiral birefringent pigments and the clear ink are closely matched such that under normal illumination conditions, i.e., sun light, room/office light, etc., the printed mark remains invisible to the naked-eye. As shown in FIG. 1, “1” indicates maximum nominal brightness of reflection from the reflective background. The contrast between the printed feature and the background is generally about 1, indicating that the security mark cannot be distinguished from the background based on their brightness. The clear carrier may include materials such as polyurethane lacquer, UV inks, epoxy resins, etc. In certain preferred embodiments, the clear carrier comprises UV curable clear inks.

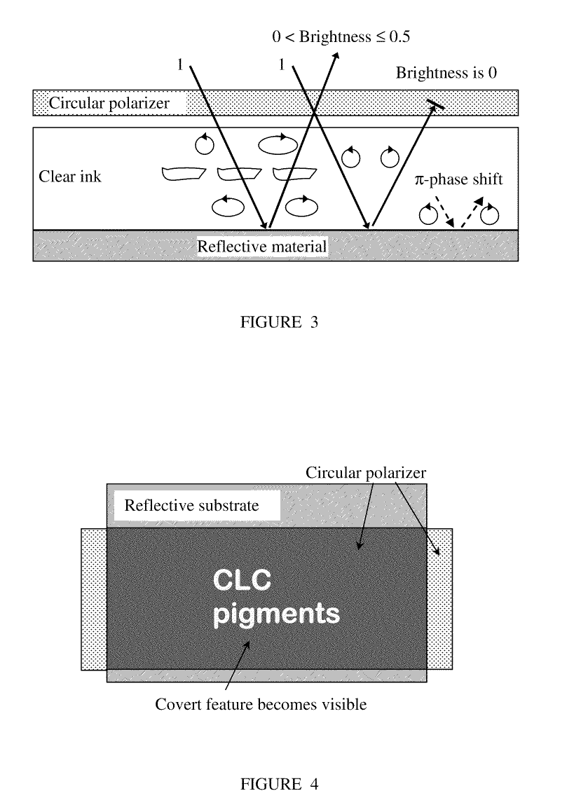

FIG. 3 demonstrate a circularly polarized incident beam that intersects the chiral birefringent flakes (the mark) and therefore can emerge through the polarizer. Another beam which does not intersects any chiral birefringent flake (background) will be absorbed by the polarizer. FIG. 4 demonstrate how the security mark becomes visible as a bright achromatic mark on a dark background.

As shown in FIG. 4, the transparent chiral birefringent pigments on the reflective background become visible when viewed with a circular polarizer. The reflected beam intensity depends on whether or not the beam intersects the chiral birefringent pigments. FIG. 3 indicates the approximate intermediate polarization states of various stages in the reflected beams. When viewed through a circular polarizer, light reflected from the background reverses its circular polarization handedness from left-handed to right-handed polarization (or vice versa). This portion of light that does not intersect the chiral birefringent transparent pigments is then blocked by the circular polarizer and appears dark to the observer (nominal brightness is “0”). In contrast, circularly polarized light that passes through the part of the mark with transparent chiral birefringent pigments accumulates additional phase. Therefore, this reflected light will in general be elliptical and part of it will pass through the circular polarizer and the mark will appear bright on a dark background.

Transparent chiral birefringent pigments such as transparent CLC pigments have strong birefringence. However, due to the helical configuration of the molecules (see FIG. 1) the flake behaves effectively as a negative uniaxial birefringent layer with the optical axis parallel to the helical axis and perpendicular to the surface. Therefore, when circularly polarized light passes through this layer at normal incidence, no phase change (or very little) occurs. The viewer will perceive a dim signal at this angle and, therefore, the feature and the background are barely distinguishable. However, when viewed away from normal incidence angle, where light is no longer propagating along the optical axis, the effect of birefringence is not negligible and the mark becomes brighter and hence more visible. Though the degree of birefringence is usually smaller than that of the positive birefringence materials, it is significant enough for viewers to detect a visible signal. In practice, due to the less than ideal planar orientation of printed pigments, there is always some residue birefringence even at normal incidence. In addition, the effective viewing angle is never “0” at normal incidence due to the imperfect planar orientation of the flakes. However, it is evident that the signal at normal is significantly weaker than the signal at larger angles (e.g., greater than about 30 degrees). The above feature of transparent pigments having linear birefringence and a periodic chiral structure properties, such as CLC, is unique and is not shared by pigments only possessing linear birefringence, such as non-chiral nematic liquid crystal pigments described by U.S. Pat. No. 7,297,292, as well as mica and calcite or pigments flakes made of stretched polymer films.

We observed that due to inevitable thickness variations of any flakes, nematic flakes appear to reflect multiple discernable colors that vary with the viewing angle when viewed with circular polarizer. In contrast, we discovered that transparent CLC pigments have an achromatic bright uniform appearance under the same viewing condition over a large viewing cone even though they too have thickness variations. The above-mentioned feature and the fact that the signal brightness is peaked at large viewing angle make said CLC pigments distinguishable from the non-chiral birefringent pigments and allows for easy authentication and, at the same time, difficult to counterfeit by ubiquitous non-chiral birefringent pigments such as mica flakes.

In addition to visual detection, optical signals reflected from the transparent chiral birefringent pigments at their intrinsic reflection bands—in UV or IR—can be detected using a spectrometer as a secondary detection. The invisibility of the reflection band allows more freedom in designing custom marking at different wavelengths. Another secondary detection feature is the circular polarization nature of the reflected light in the invisible reflection band. A simple detection system for this feature consists of a circular polarizer in front of a detector which is sensitive only to wavelengths inside the invisible reflection band. A large signal is detected when the circular polarizer matches the circular nature of the light reflected by the CLC pigments while the signal is low for a polarizer of an opposite circular sense.

In certain preferred embodiments, it is desirable to index-match the visibly transparent chiral birefringent pigments to their carrier (binder) and the overcoat materials to eliminate light scattering from their interfaces to render them invisible to the naked eye. In preferred embodiments, where cholesteric liquid crystal polymers flakes are employed as the transparent chiral birefringent pigments, the birefringent properties it possesses include two different indices of refraction. The pigment carrier and the overcoat are usually optically isotropic materials, whereby each possesses only one index of refraction. Mismatch between the indices of the pigments and their carrier or overcoat lead to light scattering that may be observable by the naked eye and may render the mark visible. To minimize the light scattering it is desirable to choose materials such that the difference among the carrier, the overcoat, and pigment indices will be as small as possible. In one embodiment, the reflective background should not be mirror-like but rather have a reflective surface that has a diffusive component. By making the whole area where the invisible mark is embedded to appear diffusive, one can hide the light scattering from the pigments. On the other hand, the reflective surface should not be too diffusive as to destroy polarization of the incident light. In another preferred embodiment, a non-birefringent, light scattering material is added to the overcoat clear ink such that the background scattering is similar to the light scattering from the security ink, thus rendering the mark undetectable by the naked eye.

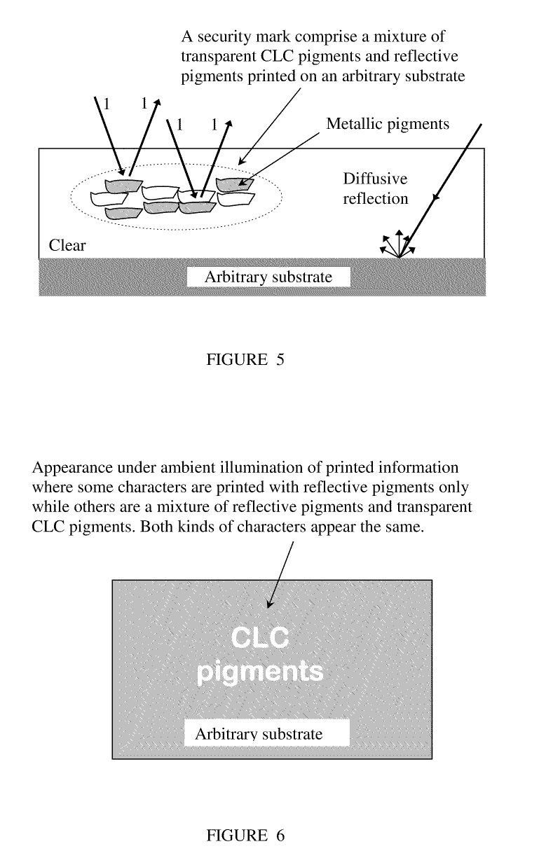

Referring now to FIG. 5, sectional view of another embodiment of the invention is shown, wherein chiral birefringent pigments that are transparent to the visible spectrum of light (such as transparent CLC pigments) are mixed with reflective pigments and clear ink. The reflective pigments may be formed from reflective material such as metals (e.g., aluminum, silver, gold or copper), inorganic interference pigments and/or pearlescent pigments, and OVPs. The clear ink carrier includes materials such as polyurethane lacquer, UV inks and/or epoxy resins. In certain preferred embodiments, the clear ink comprises clear UV curable inks. As shown in FIG. 5, the reflection from the reflective pigments is nominally “1” indicating maximum brightness.

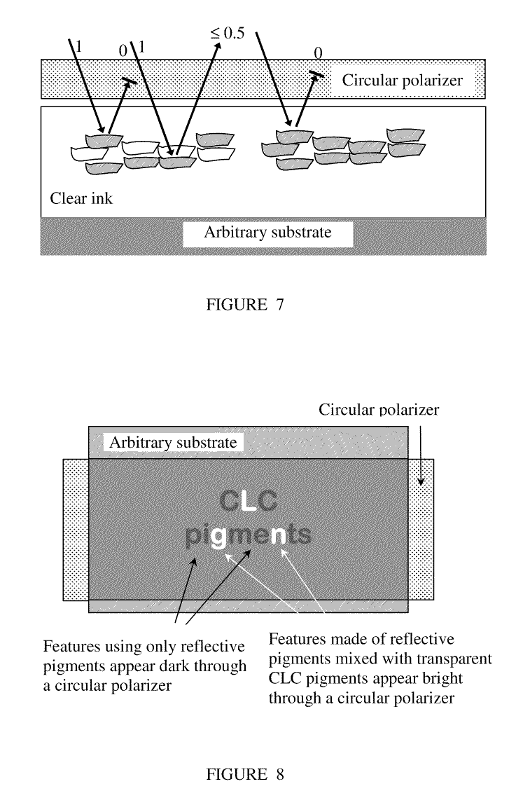

In further embodiments, and referring now to FIGS. 6, 7, and 8, the mixture of reflective pigments and security pigments (i.e., chiral birefringent platelets) can be arranged in a manner whereby certain parts of the article contains only reflective pigments, and the other parts contain the mixture of the security ink and the reflective pigments. This arrangement allows the authenticator to encode the security feature in different positions of the article thus, further enhancing the anti-counterfeit aspects and making the encoding more difficult to forge. For instance, FIG. 6 shows a code (embodied within the name “CLC pigments”) that appears as bright and uniform letters. However, certain letters are printed with reflective pigments only, and other letters are printed with a mixture of reflective pigments and pigments of chiral birefringent materials. In this manner, and referring now to FIG. 8, when viewed with a circular polarizer, it becomes apparent that certain letters are encoded (e.g., the letters “L”, “g” and “n”).

Note that the various pigments, mixtures and the like described herein may be applied directly, or alternatively, such pigments or pigment mixtures may be formulated with suitable carrier materials and/or adhesives, as is known in the ink formulation art. For example, suitable carriers and adhesives are disclosed in U.S. Pat. Nos. 5,364,557, 5,599,412, and 6,338,807, which are incorporated by reference herein and mentioned hereinafter. Such materials may be applied, e.g., to a document, banknote or other article to be encoded or marked with a herein described pigment mixture. The adhesives and/or carriers may be present in amounts of 0% to over 99% of the material mixture, depending on various factors. Such application may be by methods of printing including, but not limited to, screen-printing, gravure, ink jet printing, roller printing, pens, crayons, brush applications, or other methods, as disclosed in aforementioned U.S. Pat. Nos. 5,364,557, 5,599,412, and 6,338,807. Further, the pigment mixtures described herein may be applied by dry printing methods and systems, e.g., as disclosed in Jiang et al. U.S. Pat. Nos. 6,515,717 issued on Feb. 4, 2003 entitled “Computer-Based System for Producing Multi-Color Multilayer Images on Substrates Using Dry Multi-Colored Cholesteric Liquid Crystal (CLC) Pigment Materials Applied to Binder Material Patterns”, and 6,387,457 issued on May 14, 2002 entitled “Method of Dry Printing and Painting”, both of which are incorporated by reference herein.

The chiral birefringent materials may include any suitable materials that reflect substantially one circular polarization state (e.g., only left-handed or right-handed circularly polarized light). Such polarization reflective materials, for example, may include pigments based on CLC materials. Preferably, such CLC materials are provided as polymeric materials. CLC polymers are crosslinked organic materials with their molecules fixed in the cholesteric phase. For example, siloxane and acrylate based CLC pigments are known. One format for such CLC polymers used herein is based on a CLC polymer film that is generally fractured into small platelets, retaining all the optical properties of the CLC film. Such materials are described, for example, in Faris U.S. Pat. Nos. 5,364,557 issued on Nov. 15, 1994 entitled “Aligned Cholesteric Liquid Crystal Inks”, 5,599,412 issued on Feb. 4, 1997 entitled “Method and Apparatus for Producing Aligned Cholesteric Liquid Crystal Inks”, and 6,338,807 issued on Jan. 15, 2002 entitled “Cholesteric Liquid Crystal [CLC] Based Coloring Media for Producing Color Effects Having Improved Brightness and Color Characteristics”, all of which are incorporated herein by reference. CLC pigments that reflect visible light are also commercially available from Sicpa under the trade name Helicone®.

Many different articles require anti-counterfeiting measures. For example, it is very desirable to prevent counterfeiting of paper products such as currency, bank notes, stock certificates, stationary, legal documents and tickets. In addition, other articles of value may require anti-counterfeiting measures such as tokens, chips, pharmaceutical products, consumer healthcare products, food, software, media (DVDs, videocassettes), consumer electronic devices, industrial electronic devices, military electronic devices, batteries, medical devices, luxury goods (e.g., designer clothing, handbags, wallets), eyewear, artwork, collectibles including sports and celebrity memorabilia, automotive parts, jewelry, wristwatches and other timepieces, tobacco products, alcoholic beverages, or any article whereby authenticity is important to the consumer, the manufacture, the retailers, or any or all of the above. Thus, all of the above articles may be protected implementing the security ink systems and methods described herein.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. A security ink system comprising:
a reflective base layer; and
security pigments comprising transparent chiral birefringent material; and
a transparent ink carrier;
wherein the security ink appears invisible when viewed with naked eye, and the security ink appears visible when viewed with a circular polarizer.

2. The security ink system as in claim 1, wherein the reflective base layer is partially diffusive.

3. The security ink system as in claim 1, wherein the security pigments comprise platelets of cholesteric liquid crystal polymer film.

4. The security pigments as in claim 1, wherein the size of the transparent chiral birefringent pigments is between 5 to 100 micrometers.

5. The security pigments as in claim 1, wherein the thickness of the transparent chiral birefringent pigments is between 1 to 10 micrometers.

6. The security ink system as in claim 1, wherein the security pigments have reflection peaks in the ultraviolet region.

7. The security ink system as in claim 1, wherein the security pigments have reflection peaks in the infrared region.

8. The security ink system as in claim 1, wherein the security pigments have a birefringence level greater than 0.01.

9. A security pigment mixture comprising:
pigments formed of transparent chiral birefringent material mixed with reflective pigments;
wherein the security pigment mixture appear highly reflective when viewed with or without a circular polarizer.

10. The security pigment system as in claim 9, wherein the mixture of pigments formed of transparent chiral birefringent and reflective pigments are further mixed with a transparent carrier.

11. The security pigment system as in claim 9, wherein the security pigments comprise platelets of cholesteric liquid crystal polymer.

12. The security pigments as in claim 9, wherein the size of the transparent chiral birefringent pigments is between 5 to 100 micrometers.

13. The security pigments as in claim 9, wherein the thickness of the transparent chiral birefringent pigments is between 1 to 10 micrometers.

14. The security pigment system as in claim 9, wherein the security pigments have reflection peaks in the ultraviolet region.

15. The security pigment system as in claim 9, wherein the security pigments have reflection peaks in the infrared region.

16. The security pigment system as in claim 9, wherein the security pigments have a birefringence level greater than 0.01.

17. A system for encoding an article comprising applying a security pigment system as in claim 9 to certain portions of an article and applying reflective platelets to other portions of an article, wherein the entire article appears visible viewed without a circular polarizer, and only portions having security pigments appear to be distinguishable when viewed with a circular polarizer.
